(19) United States
(12) Patent Application Publication
(10) Pub. No.: US 2025/0368216 A1
(43) Pub. Date: Dec. 4, 2025

(54) DRIVING ASSISTANCE DEVICE, VEHICLE, CONTROL METHOD FOR DRIVING ASSISTANCE DEVICE, AND STORAGE MEDIUM

(71) Applicant: HONDA MOTOR CO., LTD., Tokyo (JP)

(72) Inventors: Misako KOIKE, Wako-shi (JP); Kosuke NAKANISHI, Wako-shi (JP); Gakuyo FUJIMOTO, Wako-shi (JP)

(21) Appl. No.: 19/219,616

(22) Filed: May 27, 2025

(30) Foreign Application Priority Data
May 30, 2024 (JP) 2024-088231

(51) Int. Cl. B60W 50/14

(52) U.S. Cl. CPC B60W 50/14; B60W 2050/143; B60W 2540/225; B60W 2554/4044; B60W 2554/804; B60W 2710/30

(57) ABSTRACT

A driving assistance device comprises a detection unit configured to detect a notification object as a target for a notification to a driver of a vehicle on the basis of surrounding information of the vehicle; a notification unit configured to issue a notification in a case where a notification condition is satisfied; an estimation unit configured to estimate a line-of-sight direction of the driver; a determination unit configured to determine whether or not the driver has averted his/her line of sight from the notification object on the basis of the line-of-sight direction; and a suppression unit configured to suppress the notification by the notification unit even in a case where the notification condition is satisfied until a predetermined condition is satisfied after the driver has averted his/her line of sight from the notification object.

### CROSS-REFERENCE TO RELATED APPLICATION(S)

This application claims priority to and the benefit of Japanese Patent Application No. 2024-088231, filed on May 30, 2024, the entire disclosure of which is incorporated herein by reference.

### BACKGROUND OF THE INVENTION

### Field of the Invention

The present invention relates to a driving assistance device, a vehicle, a control method of a driving assistance device, and a storage medium.

### Description of the Related Art

Japanese Patent Laid-Open No. 2022-134352 discloses that in a case where an occupant detects an attention target that the occupant should focus on is detected and the occupant does not direct his/her line of sight toward the attention target, a marker display is performed to guide the line of sight, and in a case where the occupant directs his/her line of sight toward attention target, a marker display is not performed.

However, the driver does not continue looking at an attention target that the driver has viewed once during driving. Even when the user does not continue looking, the attention target may be captured in the peripheral field of view, and the driver is mentally paying attention to the attention target, for example, estimating the approximate movement thereof. In the technique disclosed in Japanese Patent Laid-Open No. 2022-134352, since a notification is issued when the driver does not direct his/her line of sight toward the attention target, there is a problem that there is a possibility of excessive notifications.

### SUMMARY OF THE INVENTION

The present invention has been made in view of the above problems, and provides a technique for suppressing excessive notifications to a driver.

According to one aspect of the present invention, there is provided a driving assistance device comprising: a detection unit configured to detect a notification object as a target for a notification to a driver of a vehicle on the basis of surrounding information of the vehicle; an estimation unit configured to estimate a line-of-sight direction of the driver; a first control unit configured to control a visual confirmation flag to turn ON in a case where the driver has visually checked the notification object on the basis of the line-of-sight direction, the visual confirmation flag indicating whether or not the driver has visually checked the notification object; a second control unit configured to control a recognition flag to turn ON in a case where the visual confirmation flag is turned ON, the recognition flag indicating whether or not the driver has recognized the notification object; and a suppression unit configured to suppress the notification while the recognition flag is turned ON, wherein the first control unit controls the visual confirmation flag to turn OFF in response to the driver averting his/her line of sight from the notification object while the recognition flag is turned ON, and the second control unit controls the recognition flag to turn OFF in a case where a predetermined condition is satisfied after the visual confirmation flag is turned OFF.

### BRIEF DESCRIPTION OF THE DRAWINGS

FIG. 1 is a block diagram of a vehicle and a control device according to an embodiment;

FIG. 2 is a flowchart illustrating a procedure of processing executed by a driving assistance device according to an embodiment;

FIG. 3 is an explanatory diagram of a bounding box regarding visual confirmation determination according to a modification example;

FIG. 4 is an explanatory diagram of Gaussian distribution regarding visual confirmation determination according to a modification example;

FIG. 5 is an explanatory diagram of a notification condition at the time of right turn and left turn of a vehicle according to an embodiment;

FIG. 6 is an explanatory diagram of a notification condition in a case where a preceding vehicle is present in front of a vehicle according to an embodiment; and

FIG. 7 is an explanatory diagram of a notification condition in a case where a notification object is present in front of a vehicle according to an embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### <Control Device and Application Example Thereof>

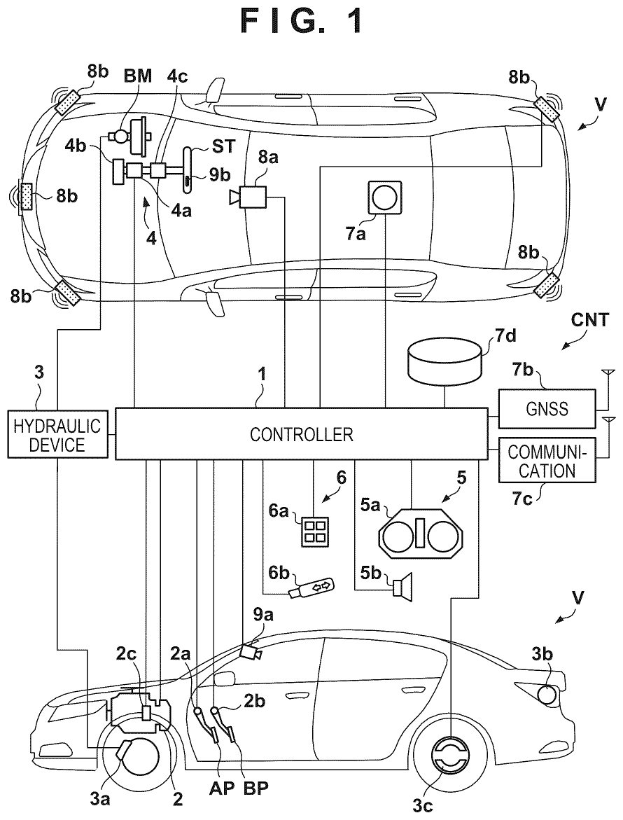

FIG. 1 is a block diagram of a control device CNT according to an embodiment of the present invention and also a schematic diagram of a vehicle V which is an application example of the control device CNT. In FIG. 1, an outline of the vehicle V is illustrated in a plan view and a side view. The vehicle V according to the present embodiment is, for example, a sedan-type four-wheeled passenger vehicle, and may be, for example, a parallel hybrid vehicle. Note that the vehicle V is not limited to the four-wheeled passenger vehicle, and may be a straddle type vehicle (motorcycle, three-wheeled vehicle) or a large vehicle such as a truck or a bus.

The control device CNT includes a controller 1 which is an electronic circuit that executes control of the vehicle V including driving assistance of the vehicle V. The controller 1 includes a plurality of electronic control units (ECUs). For example, an ECU is provided for each function of the control device CNT. Each ECU includes a processor represented by a central processing unit (CPU), a storage device such as a semiconductor memory, an interface with an external device, and the like. The storage device stores a program to be executed by the processor, data used for processing by the processor, and the like. The interface includes an input/output interface and a communication interface. Each ECU may include a plurality of processors, a plurality of storage devices, and a plurality of interfaces. A program to be stored in the storage device may be stored in the storage device by being installed in the control device CNT using a storage medium such as a CD-ROM.

The controller 1 controls driving (acceleration) of the vehicle V by controlling a power unit (power plant) 2. The power unit 2 is a travel driving unit that outputs driving force for rotating drive wheels of the vehicle V and can include an internal combustion engine, a motor, and an automatic transmission. The motor can be used as a drive source for accelerating the vehicle V and can also be used as a generator at the time of deceleration or the like (regenerative braking).

In the present embodiment, the controller 1 controls the outputs of the internal combustion engine and the motor or switches a gear ratio of the automatic transmission, for example, in response to driver's driving operation detected by an operation detection sensor 2a provided in an accelerator pedal AP and by an operation detection sensor 2b provided in a brake pedal BP and in accordance with a speed of the vehicle V detected by a rotation speed sensor 2c. Note that the rotation speed sensor 2c that detects a rotation speed of an output shaft of the automatic transmission is provided in the automatic transmission as a sensor for detecting a traveling state of the vehicle V. The vehicle speed of the vehicle V can be calculated from a detection result of the rotation speed sensor 2c.

The controller 1 controls braking (deceleration) of the vehicle V by controlling a hydraulic device 3. A driver's braking operation on the brake pedal BP is converted into hydraulic pressure in a brake master cylinder BM and transmitted to the hydraulic device 3. The hydraulic device 3 is an actuator capable of controlling a hydraulic pressure of a hydraulic oil supplied to a brake device 3a (for example, a disc brake device) provided on each of the four wheels on the basis of the hydraulic pressure transmitted from the brake master cylinder BM.

The controller 1 can control braking of the vehicle V by performing drive control of an electromagnetic valve or the like included in the hydraulic device 3. In addition, the controller 1 can also configure an electric servo brake system by controlling the distribution of the braking force by the brake device 3a and the braking force by the regenerative braking of the motor included in the power unit 2. The controller 1 may turn ON a brake lamp 3b at the time of braking.

The controller 1 controls the steering of the vehicle V by controlling an electric power steering device 4. The electric power steering device 4 includes a mechanism for steering front wheels in response to the driver's driving operation (steering operation) on a steering wheel ST. The electric power steering device 4 includes a drive unit 4a that exerts a driving force (may be denoted as steering assist torque) for assisting the steering operation or automatically steering the front wheels of the vehicle V. The drive unit 4a includes a motor as a drive source. In addition, the electric power steering device 4 further includes a steering angle sensor 4b that detects a steering angle, and a torque sensor 4c that detects steering torque (also, referred to as steering load torque, and is distinguished from steering assist torque) applied to the driver.

The controller 1 controls an electric parking brake device 3c provided in each of the rear wheels of the vehicle V. Each electric parking brake device 3c includes a mechanism for locking the corresponding rear wheel. The controller 1 can control locking and unlocking of the rear wheel by the electric parking brake device 3c.

The controller 1 controls an information output device 5 that provides information to the inside of the vehicle. The information output device 5 includes, for example, a display device 5a that notifies the driver of information using an image and/or a voice output device 5b that notifies the driver of information using a voice. Examples of the display device 5a include a display device provided in an instrument panel and a display device provided in the steering wheel ST. In addition, the display device 5a may include a head-up display. The information output device 5 may notify an occupant of information using vibration or light.

The controller 1 receives an instruction input from the occupant (for example, driver) via an input device 6. The input device 6 is disposed at a position operable by the driver, and includes, for example, a switch group 6a for the driver to instruct the vehicle V and/or a blinker lever 6b for operating a direction indicator (blinker).

The controller 1 recognizes and determines a current position and a course (attitude) of the vehicle V. In the present embodiment, the vehicle Vis provided with a gyro sensor 7a, a global navigation satellite system (GNSS) sensor 7b, and a communication device 7c. The gyro sensor 7a detects a rotational motion (yaw rate) of the vehicle V. The GNSS sensor 7b detects a current position of the vehicle V. In addition, the communication device 7c performs wireless communication with a server that provides map information and traffic information, and then acquires such information. In the present embodiment, the controller 1 determines the course of the vehicle V on the basis of detection results of the gyro sensor 7a and the GNSS sensor 7b, sequentially acquires map information regarding the course from the server via the communication device 7c, and stores the map information in a database 7d (storage device). Note that the vehicle V may be provided with another sensor for detecting the state of the vehicle V, such as an acceleration sensor for detecting the acceleration of the vehicle V.

The controller 1 executes the driving assistance of the vehicle V on the basis of detection results of various detection units provided in the vehicle V. The vehicle V includes surrounding detection units 8a and 8b serving as external sensors that detect the outside (surrounding situation) of the vehicle V, and in-vehicle detection units 9a and 9b serving as in-vehicle sensors that detect a situation inside the vehicle (the state of occupants, particularly, the driver). The controller 1 can ascertain the surrounding situation of the vehicle V on the basis of the detection results of the surrounding detection units 8a and 8b, and then execute the driving assistance of the vehicle V according to the surrounding situation. In addition, the controller 1 can determine whether or not the driver is performing a predetermined operation obligation imposed on the driver when executing the driving assistance, on the basis of the detection results of the in-vehicle detection units 9a and 9b.

The surrounding detection unit 8a is an imaging device (hereinafter, may be denoted as a front camera 8a) that captures an image of the front of the vehicle V, and is attached to the vehicle interior side of the windshield at the front portion of the roof of the vehicle V, for example. The controller 1 can extract a contour of a target object or a lane marking (white line and the like) on a road by analyzing the image captured by the front camera 8a.

The surrounding detection unit 8b is a millimeter wave radar (hereinafter, may be denoted as a radar 8b), detects a target object around the vehicle V using radio waves, and detects (measures) a distance to the target object and a direction (azimuth) of the target object with respect to the vehicle V. In the example illustrated in FIG. 1, five radars 8b are provided, one at the center of the front portion of the vehicle V, one at each of the left and right corner portions of the front portion, and one at each of the left and right corner portions of the rear portion.

Note that the surrounding detection unit provided in the vehicle Vis not limited to the above configuration, and the number of cameras and the number of radars may be changed, or a light detection and ranging (LIDAR) for detecting a target object around the vehicle V may be provided.

The in-vehicle detection unit 9a is an imaging device (hereinafter, may be denoted as an in-vehicle camera 9a) that captures an image of the inside of the vehicle, and is attached to the vehicle interior side at the front portion of the roof of the vehicle V, for example. In the present embodiment, the in-vehicle camera 9a is a driver monitor camera that captures an image of the driver (for example, driver's eyes and face). The controller 1 can determine the direction of the line of sight and the face of the driver by analyzing the image (a face image of the driver) captured by the in-vehicle camera 9a.

The in-vehicle detection unit 9b is a grip sensor (hereinafter, may be denoted as a grip sensor 9b) that detects grip of the steering wheel ST by the driver, and is provided in at least a part of the steering wheel ST, for example. Note that as the in-vehicle detection unit, the torque sensor 4c that detects the steering torque of the driver may be used.

### <Example of Driving Assistance Control>

Examples of the driving assistance of the vehicle V provided to the driver include acceleration/deceleration assistance, lane keeping assistance, and lane change assistance. The acceleration/deceleration assistance corresponds to driving assistance (adaptive cruise control (ACC)) in which the controller 1 automatically controls acceleration/deceleration of the vehicle V within a predetermined speed range by automatically controlling both the power unit 2 and the hydraulic device 3 on the basis of the map information and the detection result of the surrounding detection unit 8. In a case where there is a preceding vehicle, ACC can also be executed to perform acceleration/deceleration of the vehicle V so that the inter-vehicle distance with the preceding vehicle is kept constant. ACC is effective to reduce a burden on the driver in his/her acceleration/deceleration operation (operation on the accelerator pedal AP or the brake pedal BP).

The lane keeping assistance corresponds to driving assistance (lane keeping assist system (LKAS)) in which the controller 1 automatically controls the electric power steering device 4 on the basis of the map information and the detection result of the surrounding detection unit 8 so that the vehicle V keeps running within the lane. LKAS is effective to reduce a burden on the driver in a steering operation (operation on the steering wheel ST) during the straight-ahead running of the vehicle V.

The lane change assistance corresponds to driving assistance (advanced lane change (ALC) or active lane change assist (ALCA)) in which the controller 1 changes the lane on which the vehicle Vis running, to the adjacent lane by automatically controlling the power unit 2, the hydraulic device 3, and the electric power steering device 4 on the basis of the map information and the detection result of the surrounding detection unit 8. ALC corresponds to lane change assistance based on a system request (request from control device), whereas ALCA corresponds to lane change assistance based on an occupant request. Examples of the system request include a case where a navigation system of giving a route guidance of the vehicle V to a destination requests a lane change of the vehicle V. In a case of performing the occupant request, the driver gives an instruction for a lane change by operating the input device (for example, the blinker lever 6b). Both ALC and ALCA are effective to reduce a burden on the driver in the acceleration/deceleration operation or the steering operation on the vehicle V during the lane change.

Note that some other examples of the driving assistance control may include collision cushioning braking, an ABS function, and traction control that assist in avoiding collision with a target object on a road (for example, a pedestrian, another vehicle, or an obstacle) by controlling the hydraulic device 3, and/or control of the orientation of the vehicle V.

### <Driving Assistance>

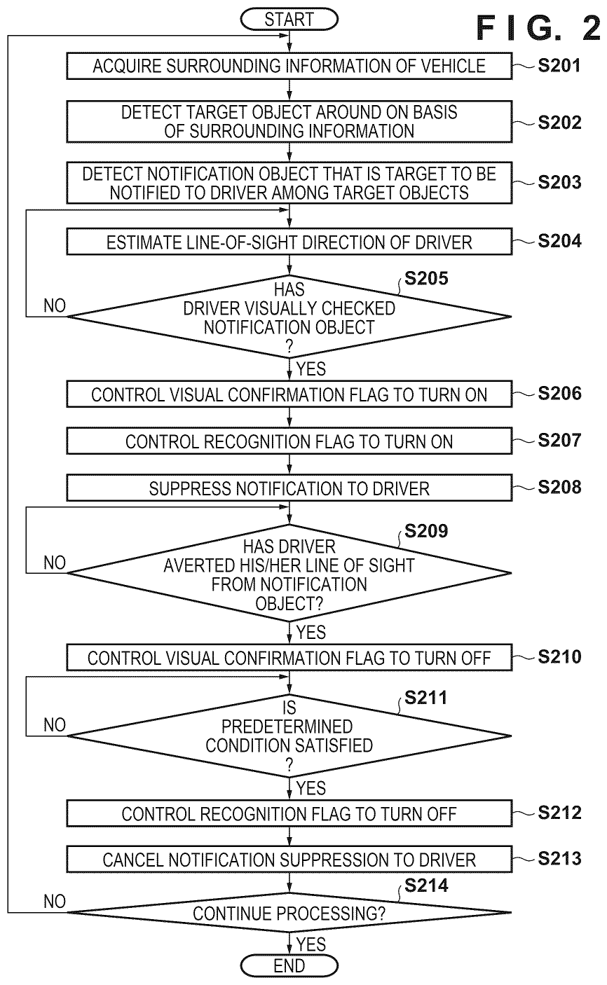

FIG. 2 is a flowchart illustrating a processing example of driving assistance control executed by the ECU included in the controller 1. In the present embodiment, the controller 1 operates as a driving assistance device.

In S201, the ECU acquires surrounding information of the vehicle V using the surrounding detection units 8a and 8b serving as external sensors for detecting the outside of the vehicle V (surrounding situation). Note that the surrounding information is continuously acquired at all times.

In S202, the ECU detects a target object present around the vehicle V on the basis of the surrounding information acquired in S201. Here, the target object may include various objects such as a traffic light, a road sign, a preceding vehicle, an adjacent vehicle, a bicycle, a pedestrian, and a running person (runner).

In S203, the ECU detects (specifies) a notification object that is a target to be notified to the driver among the target objects detected in S202. The notification to the driver is a notification for alerting the driver, and can be performed using voice and/or display via the information output device 5. The notification is issued, for example, in a case where the notification object suddenly approaches the vehicle V, or in a case where a relative position point or trajectory (movement trajectory) with respect to the vehicle V is greatly changed. The notification object is, for example, a traffic participant present around the vehicle V, and examples thereof include a four-wheeled vehicle, a two-wheeled vehicle, a pedestrian, a bicycle, and a running runner around the vehicle V.

In S204, the ECU estimates the line-of-sight direction of the driver by analyzing the image (face image of the driver) captured by the in-vehicle camera 9a.

In S205, the ECU determines whether or not the driver has visually checked the notification object on the basis of the estimated line-of-sight direction. The visual confirmation here is not limited to a case where the notification object is directly and visually checked, and may include a case where the notification object is indirectly and visually checked via a side mirror. In addition, in a case where a display that displays an image obtained by imaging the rear side of the vehicle is provided instead of the side mirror, the visual confirmation may include a case where the notification object is indirectly and visually checked via the display. In a case where the determination in this step is Yes, the processing proceeds to S206. On the other hand, in a case where the determination in this step is No, the processing returns to S204.

In S206, the ECU controls a visual confirmation flag indicating whether or not the driver has visually checked the notification object, to turn ON. The visual confirmation flag is information in ON or OFF. The notification object for which the visual confirmation flag is turned ON indicates that the driver has visually checked (has viewed) the notification object. The notification object for which the visual confirmation flag is turned OFF indicates that the driver has not visually checked (has not viewed) the notification object.

In S207, the ECU controls a recognition flag indicating whether or not the driver has recognized the notification object, to turn ON. In the present embodiment, in response to the visual confirmation flag being turned ON in S206, the recognition flag of the notification object is also controlled to be turned ON at the same time. However, the present invention is not limited to this example. The recognition flag may be controlled to be turned ON at timing when a predetermined time (for example, 0.4˜0.5 seconds) has elapsed since the visual confirmation flag is turned ON. Even in a case where the driver visually checked (visually checked) the notification object, there is a possibility that there is a time lag in the driver's understanding of what the visually checked object is. That is, a time lag may be provided until the recognition flag is turned ON in consideration of a possibility that it may take a certain time to recognize what the notification object is even when the notification object is visually checked.

In S208, the ECU performs control to suppress the notification to the driver. Even when the driver has averted his/her line of sight from the notification object in a state where the recognition flag is in an ON state, the notification object is captured in the peripheral field of view, or even when the notification object is present outside the peripheral field of view, approximate position and movement of the notification object may still be retained. When the notification is made in such a case, there is a possibility that the notification becomes excessive for the driver. Therefore, in the present embodiment, control is performed to suppress the notification in a state where the recognition flag is in the ON state. Suppression of the notification may include prohibition of the notification, reduction of the notification frequency, reduction of the notification volume, making the conditions for issuing the notification stringent, and the like. Making the conditions for issuing the notification stringent may include, for example, increasing a threshold value in a case where the notification is issued in a case where an approaching speed when the notification object suddenly approaches the vehicle V is a threshold value or more.

In S209, the ECU determines whether or not the driver has averted his/her line of sight from the notification object. Note that the line-of-sight direction of the driver is continuously estimated at all times, and it is determined whether or not the driver has averted the his/her line of sight from the notification object on the basis of the estimated line-of-sight direction. In a case where the determination in this step is Yes, the processing proceeds to S210. On the other hand, in a case where the determination in this step is No, the processing waits.

In S210, the ECU controls the visual confirmation flag to turn OFF. That is, the visual confirmation flag is changed from ON to OFF.

In S211, the ECU determines whether or not a predetermined condition is satisfied. The case where the predetermined condition is satisfied can include a case where a predetermined time change and/or a predetermined situation change occur. The case where the predetermined time change occurs may include that a predetermined time (for example, a preset time in a range of several seconds to tens of seconds) has elapsed since the visual confirmation flag is turned OFF. The case where the predetermined situation change occurs may include that the position and/or trajectory of the notification object with respect to the vehicle Vis changed beyond an allowable range.

In S212, the ECU controls the recognition flag to turn OFF. That is, the recognition flag is changed from ON to OFF. For example, when a certain time (30 seconds) has elapsed since the driver last visually checked the notification object, the information recognized by the driver becomes outdated. Therefore, the recognition flag is controlled to be turned OFF in response to the elapse of a predetermined time (for example, 30 seconds) since the visual confirmation flag is turned OFF. In addition, when the position and/or trajectory of the notification object with respect to the vehicle V is changed beyond the allowable range after the driver last visually checked the notification object, the information recognized by the driver becomes outdated. Therefore, the recognition flag is controlled to be turned OFF in response to a change in the position and/or trajectory of the notification object beyond the allowable range after the visual confirmation flag is turned OFF.

In S213, the ECU cancels the notification suppression to the driver. That is, in a state where the recognition flag is in the OFF state, in a case where the notification condition is satisfied, the notification to the driver is executed. On the other hand, in a state where the recognition flag is in the ON state, even when the notification condition is satisfied, the notification to the driver is suppressed (prohibition, reduction in frequency, making notification conditions stringent, and the like). As a result, even in a case where the driver has averted his/her line of sight from the notification object, since the notification is suppressed while it can be determined that the driver has been able to recognize the notification object, it is possible to suppress excessive notifications.

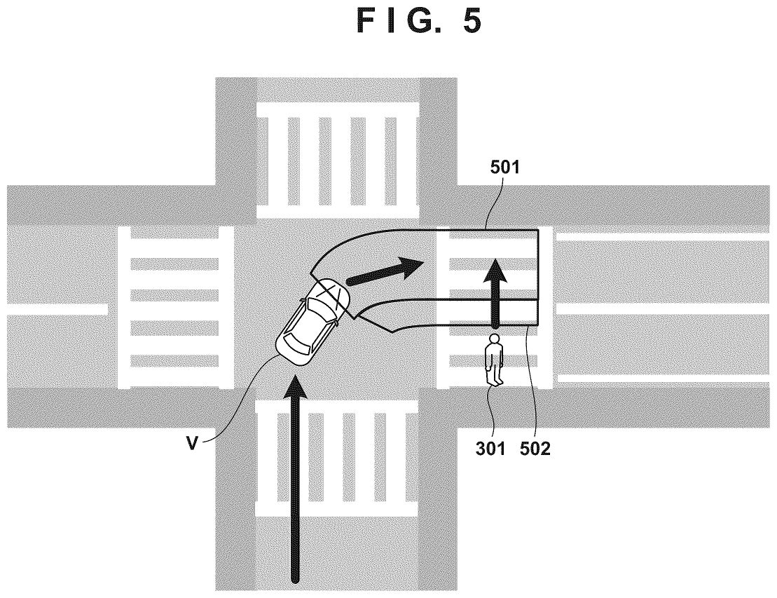

Here, the notification condition may be that an approach of a notification object (for example, a bicycle, a pedestrian, or a runner) to the vehicle Vis detected at the time of right turn and left turn of the vehicle Vin a state where the recognition flag is in the OFF state. For example, the notification condition may be that it is detected that a notification object (for example, a bicycle, a pedestrian, or a runner) is crossing a crosswalk while the vehicle V turns right. FIG. 5 is a diagram illustrating a situation where the vehicle V turns right at an intersection. A notification object 301 is about to cross a crosswalk located in a right turn direction. In this case, a warning area 502 may be set outside a predetermined area 501 in the traveling direction of the vehicle V, and the notification condition may be satisfied when it is detected that the notification object 301 has entered the warning area 502.

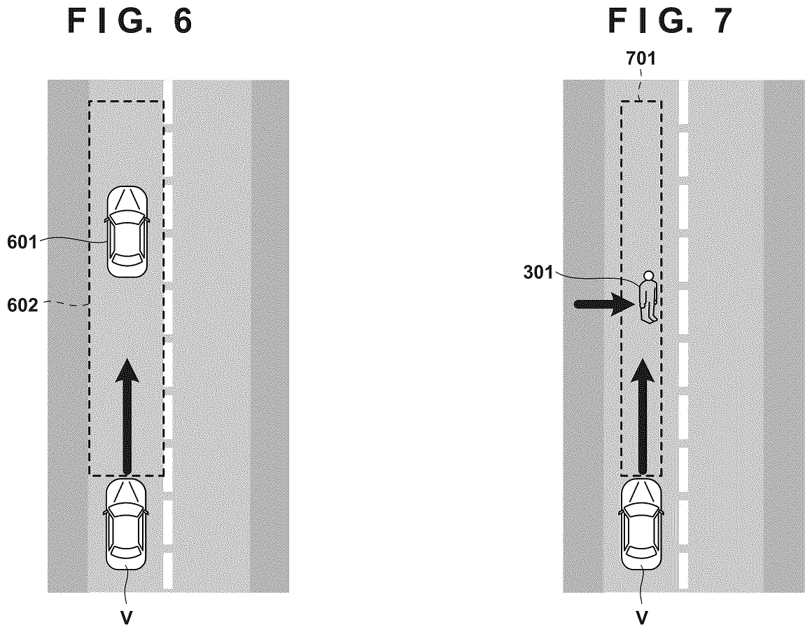

In addition, the notification condition may be that Time to Collision (TTC) is equal to or less than a threshold value in a state where the recognition flag is in the OFF state. That is, the notification may be issued in a case where a value obtained by dividing a distance between the vehicle V and a notification object (for example, a preceding vehicle) present in a predetermined area in the traveling direction of the vehicle by a relative speed between the vehicle and the notification object is equal to or less than a threshold value. FIG. 6 is a diagram illustrating a relationship between the vehicle V and a preceding vehicle traveling in front of the vehicle V. A preceding vehicle 601 is present in a predetermined area 602 in the traveling direction of the vehicle V. In this case, the TTC may be continuously calculated, and the notification condition may be satisfied in a case where the TTC becomes equal to or less than a threshold value. Alternatively, a movement average value of the TTC (the average value of a change in the TTC within a predetermined period) may be constantly calculated, and the notification condition may be satisfied in a case where a second movement average value after a predetermined time (for example, one second) becomes smaller than a first movement average value. Alternatively, the notification may be made in a case where the temporal change of the TTC indicates a decrease equal to or greater than the threshold value. In a case where the TTC is decreased by a certain amount or more in view of the temporal change of the TTC, there is a possibility that the driver is approaching suddenly in a state where the driver is unaware. In such a case, it is possible to appropriately alert the driver. For example, the notification can be issued in a case where the value of the TTC is decreased from 4 seconds to 2 seconds. On the other hand, even when the value of the TTC is small, in a case where the value of the TTC is not changed from 2 seconds to 2 seconds, there is a possibility that the driver is aware and maintains a constant inter-vehicle distance. In such a case, it is possible to suppress excessive notifications.

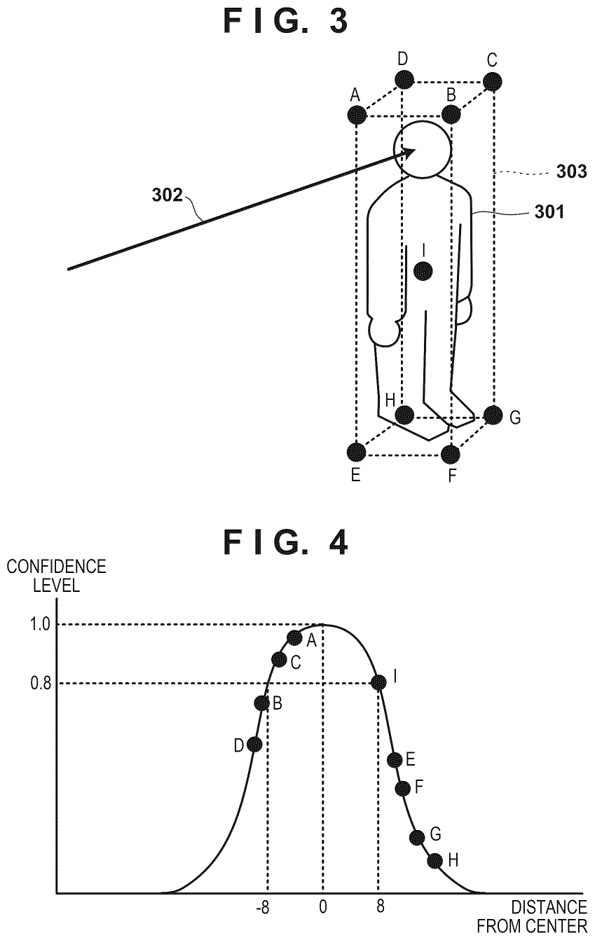

In addition, the notification condition may be that, in a state where the recognition flag is in the OFF state, the notification object (for example, a bicycle, a pedestrian, or a runner) has entered a predetermined area in the traveling direction of the vehicle V (for example, a predetermined area in front of the vehicle). FIG. 7 is a diagram illustrating a relationship between the vehicle V and a notification object. FIG. 7 illustrates a state in which a notification object has entered a predetermined area 701 in the traveling direction of the vehicle V. A bounding box of the notification object 301 described later with reference to FIG. 3 may be created, and in a case where at least one of the determination points constituting the corners of the bounding box enters the predetermined area 701, it may be determined that the notification object has entered the area.

In a case where overlooking occurs in a situation where the driver has not been able to recognize the notification object that needs to be checked again, a notification is issued to the driver for warning.

In step S214, the ECU determines whether or not to continue the processing. For example, the processing may be continued while the driver activates the vehicle V (when the engine is ON or when the power supply of an electric vehicle is ON). In a case where the determination in this step is Yes, the processing returns to S201. On the other hand, in a case where the determination in this step is No, the processing ends.

### <Transition of Visual Confirmation Flag and Recognition Flag>

In a case where the driver has viewed a notification object (for example, a runner who is running diagonally in front to the left of the vehicle V), the visual confirmation flag of the notification object is turned ON. Accordingly, the recognition flag is also turned ON immediately or after a predetermined time (0.4 to 0.5 seconds) has elapsed. Thereafter, in a case where the driver has averted his/her line of sight from the notification object, the visual confirmation flag is turned OFF. At this time, a state is obtained in which the visual confirmation flag=OFF and the recognition flag=ON. In this state, although the driver is not looking at the notification object, it is estimated that the notification object has been recognized. Therefore, even when the notification condition is satisfied, the notification is suppressed. As a result, excessive notifications can be suppressed.

In a case where a predetermined time has elapsed since the visual confirmation flag is turned OFF, it can be estimated that the driver has not been able to recognize the notification object, and thus the recognition flag is changed to OFF. Alternatively, in a case where the position and/or trajectory of the notification object with respect to the vehicle V is changed beyond the allowable range since the visual confirmation flag is turned OFF, it can be estimated that the driver has not been able to recognize the notification object, and thus the recognition flag is changed to OFF. At this time, a state is obtained in which the visual confirmation flag=OFF and the recognition flag=OFF. In this state, in a case where the notification condition is satisfied, the notification is issued. As described above, in the present embodiment, in a state where the recognition flag is in the ON state, even when the notification condition is satisfied, the notification to the driver is suppressed (prohibition, reduction in frequency, making notification conditions stringent, and the like). In other words, until the predetermined condition is satisfied (the predetermined period elapses or the position and/or trajectory of the notification object with respect to the vehicle V is changed beyond the allowable range) since the driver has averted his/her line of sight from the notification object, even in a case where the notification condition is satisfied, the notification is suppressed.

As a result, even in a case where the driver has averted his/her line of sight from the notification object, since the notification is suppressed while it can be determined that the driver has been able to recognize the notification object, it is possible to suppress excessive notifications.

### MODIFICATION EXAMPLES

In the above-described embodiment, an example has been described in which the line-of-sight direction of the driver is estimated, and in a case where an object is present ahead of the line of sight, it is determined that the target object has been visually checked. There may be various variations in a determination method of whether or not the driver has visually checked the notification object.

FIGS. 3 and 4 are explanatory diagrams of visual confirmation determination according to the present modification example. FIG. 3 illustrates a rectangular parallelepiped bounding box 303 surrounding the periphery of the notification object 301. The bounding box 303 includes a total of nine determination points including eight determination points of points A to H constituting the corners and one determination point that is the center point I. A line of sight 302 indicates a line-of-sight direction of the driver.

FIG. 4 illustrates an example of a model having an effective field of view within a predetermined range from a central vision region of the driver, and is a

Gaussian distribution diagram in which the vertical axis is a confidence level (0 to 1) of visually confirmation of the object and the horizontal axis is a distance (m) from the center of the line of sight. Among the determination points A to I, since the determination point A has the highest confidence level of visual confirmation (the determination point A is located ahead of the line of sight 302 and closest to the line of sight 302), the determination point A is adopted. Then, it is determined whether or not the confidence level of the determination point A is equal to or greater than a threshold value (for example, 0.8). In a case where the confidence level of the adopted determination point is equal to or greater than the threshold value, it is determined that the object is visually checked. On the other hand, in a case where the confidence level of the adopted determination point is less than the threshold value, it is determined that the object is not visually checked. In the illustrated example, since the confidence level of the determination point A is equal to or greater than the threshold value (for example, 0.8), it can be determined that the object is visually checked by the line of sight 302. Alternatively, the confidence level of visually checking the object even once in time series may be integrated, and it may be determined that the object is visually checked in a case where the integrated value is equal to or greater than the threshold value. For example, the integrated value may be calculated using a mathematical expression such as “1.0−(1.0−confidence level t1)×(1.0−confidence level t2)×(1.0−confidence level t3)”. Here, the confidence level tX indicates the confidence level at the time tX. As a result, the confidence level of visually checking the object can be reflected in the processing more accurately.

In the examples of FIGS. 3 and 4, the notification object 301 is a pedestrian, but can also be applied to a four-wheeled vehicle, a two-wheeled vehicle, a bicycle, a runner who is running, and the like.

In addition, in the above-described embodiment, the case where there is one notification object has been described as an example, but the present invention is not limited to this example. There may be a plurality of notification objects. In that case, it is only required to distinguish each notification object and to control ON/OFF of the visual confirmation flag and the recognition flag for each notification object.

### <Summary of Embodiments>

1. The driving assistance device (1) according to the above embodiments is a driving assistance device comprising:
a detection unit (1, 8a, 8b) configured to detect a notification object as a target for a notification to a driver of a vehicle (V) on the basis of surrounding information of the vehicle;
an estimation unit (1, 9a) configured to estimate a line-of-sight direction of the driver;
a first control unit (1) configured to control a visual confirmation flag to turn ON in a case where the driver has visually checked the notification object on the basis of the line-of-sight direction, the visual confirmation flag indicating whether or not the driver has visually checked the notification object;
a second control unit (1) configured to control a recognition flag to turn ON in a case where the visual confirmation flag is turned ON, the recognition flag indicating whether or not the driver has recognized the notification object; and
a suppression unit (1) configured to suppress the notification while the recognition flag is turned ON,
wherein the first control unit controls the visual confirmation flag to turn OFF in response to the driver averting his/her line of sight from the notification object while the recognition flag is turned ON, and
the second control unit controls the recognition flag to turn OFF in a case where a predetermined condition is satisfied after the visual confirmation flag is turned OFF.

As described above, in a state where the recognition flag is in the ON state, even when the notification condition is satisfied, the notification to the driver is suppressed, so that even in a case where the driver has averted his/her line of sight from the notification object, the notification is suppressed while it can be determined that the driver has been able to recognize the notification object. Therefore, it is possible to suppress excessive notifications to the driver.

2. In the driving assistance device (1) according to the above embodiments, the case where the predetermined condition is satisfied includes a case where a first predetermined time has elapsed.

As a result, since the recognition flag is maintained in the ON state until a predetermined time (for example, several seconds to tens of seconds) has elapsed since the visual confirmation flag is turned OFF and a predetermined time elapses since the last time the notification object is viewed (while the memory is fresh), it is possible to suppress excessive notifications during this period.

3. In the driving assistance device (1) according to the above embodiments, the case where the predetermined condition is satisfied includes a case where a position and a trajectory of the notification object are changed beyond an allowable range.

As a result, the recognition flag is maintained in the ON state until the notification object recognized by the driver is greatly changed and the deviation from the recognition becomes large, so that it is possible to suppress excessive notifications during this period.

4. In the driving assistance device (1) according to the above embodiments, the second control unit controls the recognition flag to turn ON after a second predetermined time has elapsed since the visual confirmation flag is turned ON.

As a result, it is possible to realize control in consideration of a time lag from when the driver visually checks the notification object to when the driver recognizes what the notification object is.

5. In the driving assistance device (1) according to the above embodiments, the notification is issued in response to the notification object entering a predetermined area in a traveling direction of the vehicle.

As a result, it is possible to appropriately alert the driver to sudden intrusions into where the vehicle is going to travel or the like.

6. In the driving assistance device (1) according to the above embodiments, the notification is issued in response to a value becoming equal to or less than a threshold value, the value being obtained by dividing a distance between the vehicle and the notification object present within a predetermined area in a traveling direction of the vehicle by a relative speed between the vehicle and the notification object.

As a result, in a case where the TTC becomes equal to or less than the threshold value, it is possible to appropriately alert the driver.

7. The driving assistance device (1) according to the above embodiments, further comprising
a notification unit (5) that issues a notification to the driver,
wherein the notification unit issues the notification in a case where a notification condition is satisfied.

As a result, it is possible to appropriately alert the driver.

8. In the driving assistance device (1) according to the above embodiments, the case where the notification condition is satisfied includes a case where the notification object has entered a predetermined area in a traveling direction of the vehicle.

As a result, it is possible to appropriately alert the driver to sudden intrusions into where the vehicle is going to travel or the like.

9. In the driving assistance device (1) according to the above embodiments, the case where the notification condition is satisfied includes a case where a value obtained by dividing a distance between the vehicle and the notification object present within a predetermined area in a traveling direction of the vehicle by a relative speed between the vehicle and the notification object becomes equal to or less than a threshold value.

As a result, in a case where the TTC becomes equal to or less than the threshold value, it is possible to appropriately alert the driver.

10. In the driving assistance device (1) according to the above embodiments, the case where the notification condition is satisfied includes a case where a temporal change of a value obtained by dividing a distance between the vehicle and the notification object present within a predetermined area in a traveling direction of the vehicle by a relative speed between the vehicle and the notification object indicates a decrease equal to or greater than a threshold value.

As a result, in a case where the TTC is decreased by a certain amount or more in view of the temporal change of the TTC, there is a possibility that the driver is approaching suddenly in a state where the driver is unaware. In such a case, it is possible to appropriately alert the driver. For example, the notification can be issued in a case where the value of the TTC is decreased from 4 seconds to 2 seconds. On the other hand, even when the value of the TTC is small, in a case where the value of the TTC is not changed from 2 seconds to 2 seconds, there is a possibility that the driver is aware and maintains a constant inter-vehicle distance. In such a case, it is possible to suppress excessive notifications.

11. In the driving assistance device (1) according to the above embodiments, the suppression unit prohibits the notification while the recognition flag is turned ON.

As a result, unnecessary notifications can be prevented.

12. In the driving assistance device (1) according to the above embodiments, the suppression unit reduces frequency of the notification while the recognition flag is turned ON, as compared to a case where the recognition flag is turned OFF.

As a result, unnecessary notifications can be suppressed.

13. In the driving assistance device (1) according to the above embodiments, the suppression unit makes the notification condition stringent such that the notification condition is less likely to be satisfied while the recognition flag is turned ON, as compared to a case where the recognition flag is turned OFF.

As a result, unnecessary notifications can be suppressed.

14. The driving assistance device (1) according to the above embodiments is a driving assistance device comprising:
a detection unit (1, 8a, 8b) configured to detect a notification object as a target for a notification to a driver of a vehicle (V) on the basis of surrounding information of the vehicle;
a notification unit (5) configured to issue a notification in a case where a notification condition is satisfied;
an estimation unit (1, 9a) configured to estimate a line-of-sight direction of the driver;
a determination unit (1) configured to determine whether or not the driver has averted his/her line of sight from the notification object on the basis of the line-of-sight direction; and
a suppression unit (1) configured to suppress the notification by the notification unit even in a case where the notification condition is satisfied until a predetermined condition is satisfied after the driver has averted his/her line of sight from the notification object.

As a result, even in a case where the driver has averted his/her line of sight from the notification object, the notification is suppressed while it can be determined that the driver has been able to recognize the notification object. Therefore, it is possible to suppress excessive notifications.

15. The vehicle (V) according to the above embodiments is a vehicle comprising the driving assistance device according to the above embodiments.

As a result, it is possible to realize the function of the driving assistance device according to the above embodiment on the vehicle.

16. The control method for a driving assistance device (1) according to the above embodiments is a control method for a driving assistance device, the control method comprising:
detecting (S201, S202, S203) a notification object as a target for a notification to a driver of a vehicle on the basis of surrounding information of the vehicle;
estimating (S204) a line-of-sight direction of the driver;
controlling (Yes in S205, S206) a visual confirmation flag to turn ON in a case where the driver has visually checked the notification object on the basis of the line-of-sight direction, the visual confirmation flag indicating whether or not the driver has visually checked the notification object;
controlling (S207) a recognition flag to turn ON in a case where the visual confirmation flag is turned ON, the recognition flag indicating whether or not the driver has recognized the notification object;
suppressing (S208) the notification while the recognition flag is turned ON;
controlling (Yes in S209, S210) the visual confirmation flag to turn OFF in response to the driver averting his/her line of sight from the notification object while the recognition flag is turned ON; and
controlling (Yes in S211, S212) the recognition flag to turn OFF in a case where a predetermined condition is satisfied after the visual confirmation flag is turned OFF.

As described above, in a state where the recognition flag is in the ON state, even when the notification condition is satisfied, the notification to the driver is suppressed, so that even in a case where the driver has averted his/her line of sight from the notification object, the notification is suppressed while it can be determined that the driver has been able to recognize the notification object. Therefore, it is possible to suppress excessive notifications to the driver.

17. The control method for a driving assistance device (1) according to the above embodiments is a control method for a driving assistance device, the control method comprising:
detecting a notification object as a target for a notification to a driver of a vehicle on the basis of surrounding information of the vehicle;
issuing a notification in a case where a notification condition is satisfied;
estimating a line-of-sight direction of the driver;
determining whether or not the driver has averted his/her line of sight from the notification object on the basis of the line-of-sight direction; and
suppressing the notification even in a case where the notification condition is satisfied until a predetermined condition is satisfied after the driver has averted his/her line of sight from the notification object.

As a result, even in a case where the driver has averted his/her line of sight from the notification object, the notification is suppressed while it can be determined that the driver has been able to recognize the notification object. Therefore, it is possible to suppress excessive notifications.

18. The program according to the above embodiments is a program for causing a computer to execute the control method for a driving assistance device according to the above embodiments.

As a result, it is possible to realize the processing of the driving assistance device by a computer.

19. The storage medium according to the above embodiments is a storage medium storing a program for causing a computer to execute the control method for a driving assistance device according to the above embodiments.

As a result, it is possible to realize the processing of the driving assistance device by the storage medium.

According to the present invention, it is possible to suppress excessive notifications to the driver.

The invention is not limited to the foregoing embodiments, and various variations/changes are possible within the spirit of the invention.

What is claimed is:

1. A driving assistance device comprising:
a detection unit configured to detect a notification object as a target for a notification to a driver of a vehicle on the basis of surrounding information of the vehicle;
an estimation unit configured to estimate a line-of-sight direction of the driver;
a first control unit configured to control a visual confirmation flag to turn ON in a case where the driver has visually checked the notification object on the basis of the line-of-sight direction, the visual confirmation flag indicating whether or not the driver has visually checked the notification object;
a second control unit configured to control a recognition flag to turn ON in a case where the visual confirmation flag is turned ON, the recognition flag indicating whether or not the driver has recognized the notification object; and
a suppression unit configured to suppress the notification while the recognition flag is turned ON,
wherein the first control unit controls the visual confirmation flag to turn OFF in response to the driver averting his/her line of sight from the notification object while the recognition flag is turned ON, and
the second control unit controls the recognition flag to turn OFF in a case where a predetermined condition is satisfied after the visual confirmation flag is turned OFF.

2. The driving assistance device according to claim 1, wherein the case where the predetermined condition is satisfied includes a case where a first predetermined time has elapsed.

3. The driving assistance device according to claim 1, wherein the case where the predetermined condition is satisfied includes a case where a position and a trajectory of the notification object are changed beyond an allowable range.

4. The driving assistance device according to claim 1, wherein the second control unit controls the recognition flag to turn ON after a second predetermined time has elapsed since the visual confirmation flag is turned ON.

5. The driving assistance device according to claim 1, wherein the notification is issued in response to the notification object entering a predetermined area in a traveling direction of the vehicle.

6. The driving assistance device according to claim 1, wherein the notification is issued in response to a value becoming equal to or less than a threshold value, the value being obtained by dividing a distance between the vehicle and the notification object present within a predetermined area in a traveling direction of the vehicle by a relative speed between the vehicle and the notification object.

7. The driving assistance device according to claim 1, further comprising
a notification unit that issues a notification to the driver,
wherein the notification unit issues the notification in a case where a notification condition is satisfied.

8. The driving assistance device according to claim 7, wherein the case where the notification condition is satisfied includes a case where the notification object has entered a predetermined area in a traveling direction of the vehicle.

9. The driving assistance device according to claim 7, wherein the case where the notification condition is satisfied includes a case where a value obtained by dividing a distance between the vehicle and the notification object present within a predetermined area in a traveling direction of the vehicle by a relative speed between the vehicle and the notification object becomes equal to or less than a threshold value.

10. The driving assistance device according to claim 7, wherein the case where the notification condition is satisfied includes a case where a temporal change of a value obtained by dividing a distance between the vehicle and the notification object present within a predetermined area in a traveling direction of the vehicle by a relative speed between the vehicle and the notification object indicates a decrease equal to or greater than a threshold value.

11. The driving assistance device according to claim 1, wherein the suppression unit prohibits the notification while the recognition flag is turned ON.

12. The driving assistance device according to claim 1, wherein the suppression unit reduces frequency of the notification while the recognition flag is turned ON, as compared to a case where the recognition flag is turned OFF.

13. The driving assistance device according to claim 7, wherein the suppression unit makes the notification condition stringent such that the notification condition is less likely to be satisfied while the recognition flag is turned ON, as compared to a case where the recognition flag is turned OFF.

14. A driving assistance device comprising:
a detection unit configured to detect a notification object as a target for a notification to a driver of a vehicle on the basis of surrounding information of the vehicle;
a notification unit configured to issue a notification in a case where a notification condition is satisfied;
an estimation unit configured to estimate a line-of-sight direction of the driver;
a determination unit configured to determine whether or not the driver has averted his/her line of sight from the notification object on the basis of the line-of-sight direction; and
a suppression unit configured to suppress the notification by the notification unit even in a case where the notification condition is satisfied until a predetermined condition is satisfied after the driver has averted his/her line of sight from the notification object.

15. A vehicle comprising the driving assistance device according to claim 1.

16. A control method for a driving assistance device, the control method comprising:
detecting a notification object as a target for a notification to a driver of a vehicle on the basis of surrounding information of the vehicle;
estimating a line-of-sight direction of the driver;
controlling a visual confirmation flag to turn ON in a case where the driver has visually checked the notification object on the basis of the line-of-sight direction, the visual confirmation flag indicating whether or not the driver has visually checked the notification object;
controlling a recognition flag to turn ON in a case where the visual confirmation flag is turned ON, the recognition flag indicating whether or not the driver has recognized the notification object;
suppressing the notification while the recognition flag is turned ON;
controlling the visual confirmation flag to turn OFF in response to the driver averting his/her line of sight from the notification object while the recognition flag is turned ON; and
controlling the recognition flag to turn OFF in a case where a predetermined condition is satisfied after the visual confirmation flag is turned OFF.

17. A control method for a driving assistance device, the control method comprising:
detecting a notification object as a target for a notification to a driver of a vehicle on the basis of surrounding information of the vehicle;
issuing a notification in a case where a notification condition is satisfied;
estimating a line-of-sight direction of the driver;
determining whether or not the driver has averted his/her line of sight from the notification object on the basis of the line-of-sight direction; and
suppressing the notification even in a case where the notification condition is satisfied until a predetermined condition is satisfied after the driver has averted his/her line of sight from the notification object.

18. A non-transitory computer-readable storage medium storing a program for causing a computer to execute the control method for a driving assistance device according to claim 16.

19. A non-transitory computer-readable storage medium storing a program for causing a computer to execute the control method for a driving assistance device according to claim 17.
